(19) United States
(12) Patent Application Publication
(10) Pub. No.: US 2004/0056059 A1
(43) Pub. Date: Mar. 25, 2004

(54) Cargo shelf

(76) Inventors: Manuel M. Delgado, Oxnard, CA (US); Annamaria Delgado, Sierra Madre, CA (US); Cristina Faulkner, La Mirada, CA (US)

Correspondence Address: LAW OFFICES OF JOHN E. WAGNER, 3541 Ocean View Boulevard, Glendale, CA, 91208, US

(21) Appl. No.: 10/253,070

(22) Filed: Sep. 23, 2002

(51) Int. Cl. B60R 9/00; B60R 11/00; B60R 7/00

(52) U.S. Cl. 224/499; 224/539

(57) ABSTRACT

A portable and compact storage rack for vertically dividing the cargo area of a vehicle. The storage rack includes a first base panel and a second base panel, each having a center end and a leg end. The center end of each base panel is pivotally attached to the center end of the other base panel. The rack further includes a first and a second leg, each leg being pivotally attached to the leg end of a base panel. When in a collapsed orientation, the legs are folded against the base panels and the base panels are folded together. In the collapsed orientation, the storage rack is well-suited for easy movement into and out of a vehicle, storage in small spaces, particularly under a seat of a passenger van, station wagon or sports utility vehicle, and on a shipping crate or pallet for store merchandising. When the rack of the present invention is installed in a vehicle, the base panels are unfolded to form a generally flat surface and the legs are rotated to a position generally perpendicular to that surface to support the rack above the floor of the cargo area.

### BACKGROUND OF THE INVENTION

This invention relates to a cargo management rack, and more particularly to a removable, portable storage rack adapted for easy installation in and easy removal from the cargo area of a motor vehicle.

Cargo management racks are often useful for maximizing the usable space in the cargo area of a motor vehicle. Many sport utility vehicles, station wagons, vans, minivans and other vehicles have interior cargo areas located behind the passenger seats. The cargo areas in such vehicles are generally large, open spaces that lack structures for partitioning the open space into vertical areas. The absence of dividing structures limits an operator's ability to stack items of varying sizes, shapes and weighs in the cargo area.

Early cargo organizers included cargo nets that were stretched from one side of the cargo area to the other to limit movement of cargo. Such nets did not address the need to divide the cargo area into vertical areas. Storage containers and shelf-type storage dividers are also used to provide separate cargo areas. However, these products are generally bulky and are not amenable to packaging suitable for storage on shipping crates. As such, the marketing of such products to bulk sales stores, which often display products on shipping crates, is hindered. In addition, moving and installing a rigid product having a width generally corresponding to a vehicle can be difficult.

For example, U.S. Pat. No. 6,056,177 (Schneider) discloses a collapsible storage container with interior partitions and a top panel capable of supporting the weight of items placed upon the container. The container extends the width of the cargo space and may be folded into a flat unit when not in use. Similarly, U.S. Pat. No. 5,669,537 (Saleem et al.) discloses a storage divider shelf for dividing the cargo area of a vehicle into vertically segmented compartments. The shelf is supported by a track system attached to the side walls of the cargo area. Here too, the shelf is collapsible such that the product is relatively flat when collapsed. However, both the storage container and the collapsed shelf of the prior art are rigid products having a width generally corresponding to the width of a vehicle.

There is, therefore, a need for a cargo management rack that is small, sturdy, portable, easily installed, and collapsible into a package having dimensions well-suited for movement and installation, and storage or stacking on shipping crates.

### BRIEF SUMMARY OF THE INVENTION

The present invention provides a portable and compact storage rack for vertically dividing the cargo area of a vehicle. The storage rack includes a first base panel and a second base panel, each having a center end and a leg end. The center end of each base panel is pivotally attached to the center end of the other base panel. The rack further includes a first and a second leg, each leg being pivotally attached to the leg end of a base panel.

When in a collapsed orientation, the legs are folded against the base panels and the base panels are folded together. In the collapsed orientation, the storage rack has a width that is approximately one-half the width of a vehicle, and the collapsed rack is well-suited for easy movement into and out of a vehicle, storage in small spaces, particularly under a seat of a passenger van, station wagon or sports utility vehicle, and on a shipping crate or pallet for store merchandising. When the rack of the present invention is installed in a vehicle, the base panels are unfolded to form a generally flat surface and the legs are rotated to a position generally perpendicular to that surface to support the rack above the floor of the cargo area.

In a preferred embodiment of the invention, the portable storage rack includes a positioning assembly that includes a slot in the side wall of a base panel adjacent to the center end of that base panel. A tab extends from the center end of the other base panel such that the tab is received within and held in place by the slot. The positioning assembly locks the base panels into a generally flat surface. In an alternative embodiment of the positioning assembly, one base panel includes a downwardly angled hook in the side wall adjacent to the center end of the first base panel, and the other base panel includes an upwardly angled hook extending from the center end of the base panel. The hook in the first base panel and the hook in the second base panel interconnect to lock the base panels into a generally flat surface.

In another embodiment of the invention, the base panels and the legs further include a locking assembly for securing the legs in a position that is generally perpendicular to the base panels. In particular, the base panels include a peg extending inwardly from an inner side wall. The legs include a support portion and an upper extended portion located adjacent to the hinge on the leg and extending perpendicularly relative to the support portion. The upper extended portion of the leg includes a slot. To lock the legs in an upright position, the peg is received within the leg slot when the leg is in the extended. To fold the leg, the upper extended portion of the leg is depressed toward the opposite side of the connected center panel to release the peg from the slot.

The storage rack includes additional features to reduce the weight of the rack without detracting from its other features. To this end, in a preferred embodiment, the base panels and the legs are formed from parallel slats that are held together by a brace at each end of the base panel or leg. In yet another embodiment of the invention, the storage rack includes two additional legs pivotally attached to the center end of each base panel. When unfolded, these additional legs support the center of the planar surface formed by the unfolded base panels.

These and additional features and advantages of the present invention will become more apparent from the detailed description set forth below when taken in conjunction with the drawings in which like reference characters generally identify corresponding elements throughout.

### BRIEF DESCRIPTION OF THE DRAWINGS

The accompanying drawings, which are incorporated herein and form part of the specification, illustrate embodiments of the present invention and, together with the description, further serve to explain the principles of embodiments of the invention.

FIG. 1 is a rear elevational view of a van-type vehicle with the rear door open and the storage rack of the present invention in place;

FIG. 2 is a rear elevational view of the present invention similar to FIG. 1 with the invention in a stored condition;

FIG. 3 is a perspective view of the portable storage rack of the present invention;

FIG. 4 is a top elevation view of the portable storage rack;

FIG. 5 is a partial perspective view of the base panels of the present invention;

FIG. 6 is a partial perspective view of an alternative embodiment of the base panels of the present invention;

FIG. 7 is a perspective view of the present invention in a folded condition;

FIG. 8 is a partial perspective view of the positioning assembly of the present invention;

FIG. 9 is a partial perspective view of a base panel and leg of the present invention;

FIG. 10 is a perspective view of an alternative embodiment of the present invention; and

FIG. 11 is a perspective view of packaging for this invention displayed on a pallet for retail display.

### DETAILED DESCRIPTION

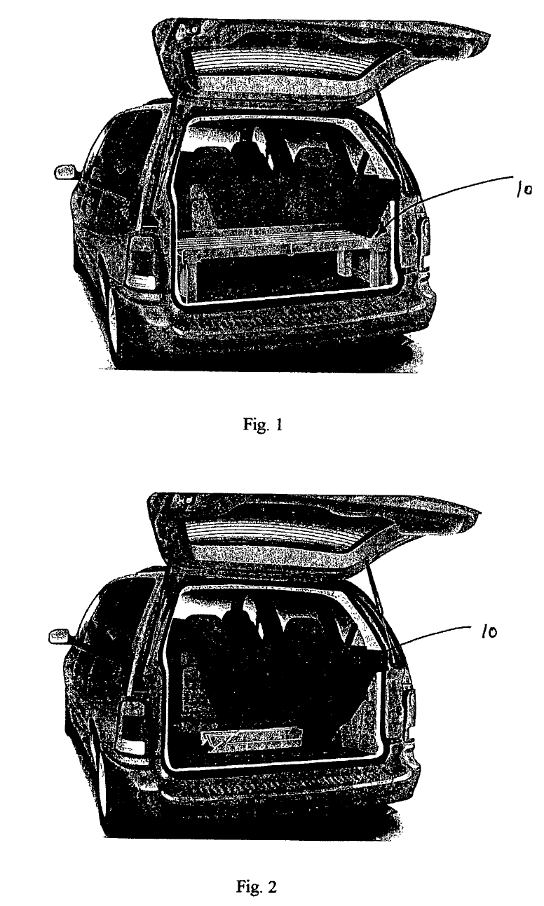

Referring to FIG. 1, a portable storage rack 10 is shown. The portable storage rack is suitable for use in a vehicle cargo area, such as the cargo area of a sport utility vehicle, van, mini-van, station wagon, or other vehicle. Similarly, the portable storage rack of the present invention may also be used within a conventional trunk compartment of a passenger vehicle or the bed of a truck.

As illustrated in FIG. 2, the storage rack may be folded to form a compact assembly that is suitable for storage under a passenger seat or other convenient location.

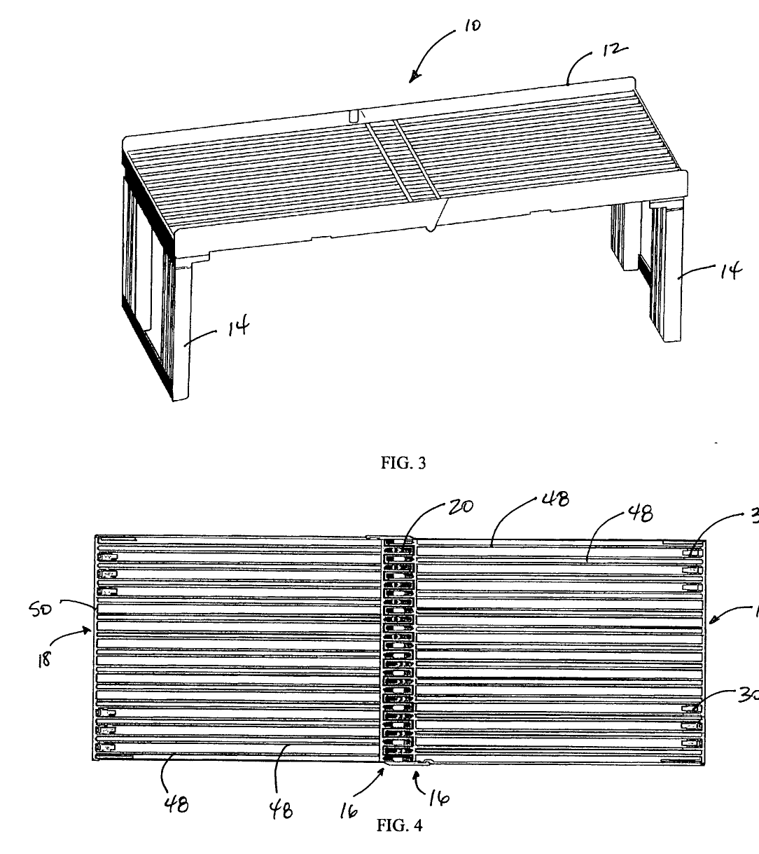

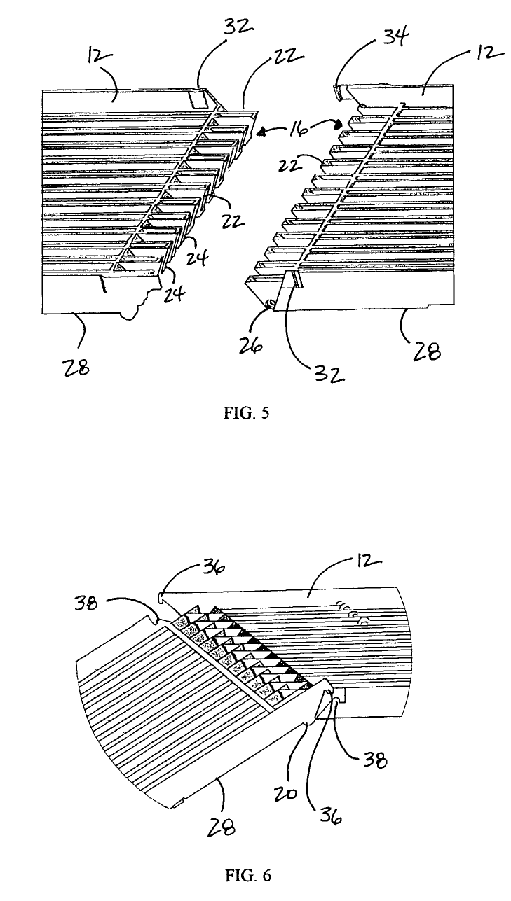

Referring to FIGS. 3 and 4, the portable storage rack 10 includes two base panels 12 and two legs 14. Each base panel has a center end 16 and a leg end 18. The base panels are pivotally attached to each other at their center ends by any suitable means, such as the base panel hinge 20 (shown in FIGS. 4 and 5). When the base panels are open (unfolded), the base panels form a generally planar surface, as shown in FIG. 3. The planar surface is suitable for the placement of cargo, such as groceries, bags, and many other objects.

As shown in FIG. 5, in the preferred embodiment, the base panel hinge 20 is an integral part of the lower edge of the center end of each base panel. In particular, the base panels include a plurality of fingers 22 integrally formed in the base panel, and extending along the longitude of the base panel from the center end 16 of each panel. The first base panel includes pins 24 extending perpendicularly from the lower surface of each finger. The second base panel includes holes 26 for receipt of the fingers.

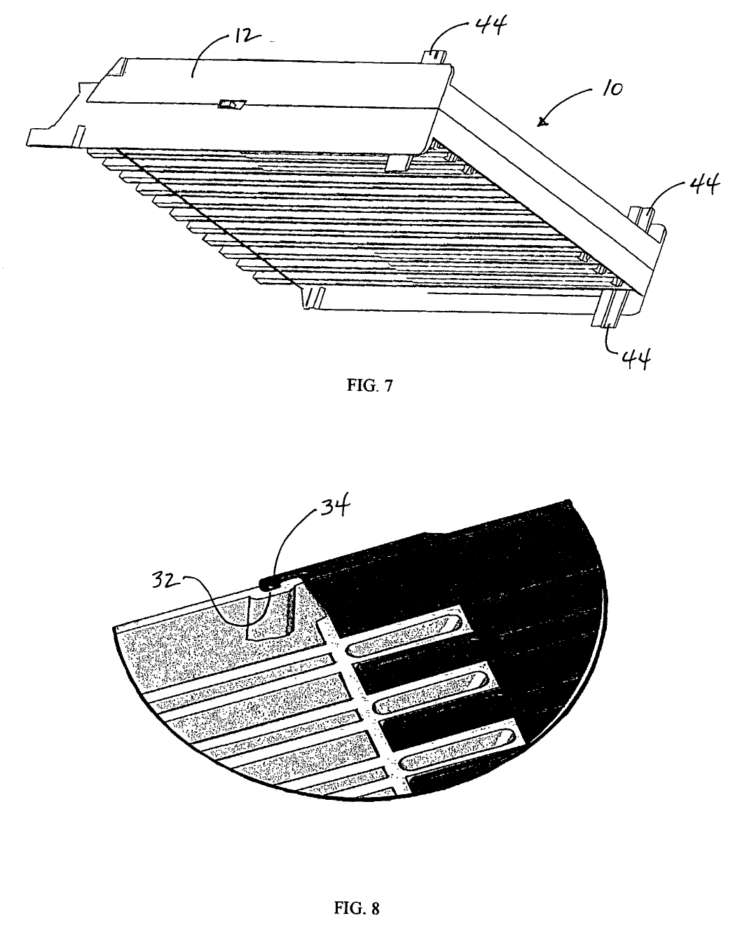

The placement of the base panel hinge results in the lower surfaces 28 of the base panel touching each other when the base panels are in a folded (collapsed) position (FIG. 7). The base panel hinge is not limited to hinges formed as part of the base panel itself. Instead, any suitable means for pivotally connecting the base panels may be used.

Each of the legs 14 is pivotally attached to the leg end 18 of a base panel 12 by any suitable means, such as a leg hinge 30 (FIG. 4). The first and second legs can be pivoted into generally upright positions as shown in FIG. 3, or collapsed and folded against the attached base panel. In an alternative embodiment, the legs may be angled slightly outward at their lower ends to provide additional stability to the storage rack 10.

In the preferred embodiment, the first and second legs are hinged to fold against the lower surface 28 of a base panel. After the legs are collapsed, the base panels may be folded together to form a compact structure, such as illustrated in FIG. 7. The folded storage rack is easily moved in and out of a vehicle, and can be conveniently stored in a small location in the vehicle or other storage location. For example, the storage rack may be stored under a seat where it takes away no normally used space in the vehicle and it is not likely to be misplaced.

In the preferred embodiment, as illustrated in FIG. 11, the folded storage rack has dimensions suitable for compact boxing and stacking on shipping crates or pallets with layers of two storage racks wide by three storage racks high, by nine storage racks deep. In this manner, the collapsed orientation of the present invention is well suited for marketing and sales through mass merchandising stores that display products on shipping crates or pallets.

In a detailed embodiment of the present invention, the base panels 12 are retained in the open position (shown in FIG. 3) by a positioning assembly. In a first embodiment of the positioning assembly, shown in FIGS. 5 and 8, the positioning assembly includes a vertical panel slot 32 in the outside side wall of a base panel 12 adjacent to the center end 16 of the base panel. The panel slot has an open end at the upper surface of the first base panel, and a closed end located vertically below the open end. The positioning assembly also includes a vertical tab 34 extending from the side wall of the other base panel, adjacent to the center end. When the base panels are open and form a generally planar surface, the tab is received within the open end of the panel slot, and the bottom of the tab rests against the closed end of the panel slot to lock the base panels in the open position.

FIG. 6 illustrates another embodiment of the positioning assembly. In this embodiment, a first base panel 12 includes a downwardly angled hook 36 in the side wall of the base panel adjacent to the center end of the base panel. The second base panel includes an upwardly angled hook 38 extending from the center end of the base panel. When the base panels are in the open position, the downwardly angled hook and the upwardly angled hook interconnect to lock the base panels together. It will be appreciated that many other structures may be used to lock the base panels into the open position. However, the locking structures of FIGS. 3 and 4 have certain important advantages to the present invention, namely (a) they are molded integrally with the base panels and thereby do not add any parts, (b) they add no or only slightly any width to the storage rack, and (c) they are automatically released merely by the act of folding the base parts together. Consequently, the locking structures described are part of the preferred embodiment.

The present invention also includes a locking assembly to retain the legs 14 in an upright position. As illustrated in FIG. 9, a base panel 12 includes a peg 40 extending inwardly from an inner side wall of the base panel. The leg 14 that is attached to the base panel includes a support portion 42 and an upper extended portion 44 (shown partially ghosted) located adjacent to hinge on the leg and extending perpendicularly relative to the support portion. The upper extended portion of the leg includes a leg slot 46 that is positioned on the leg to receive the peg when the leg is unfolded and in an upright position. To close the legs, the upper extended portion is pressed inward and away from the side wall of the base panel, and the peg is released from the leg slot.

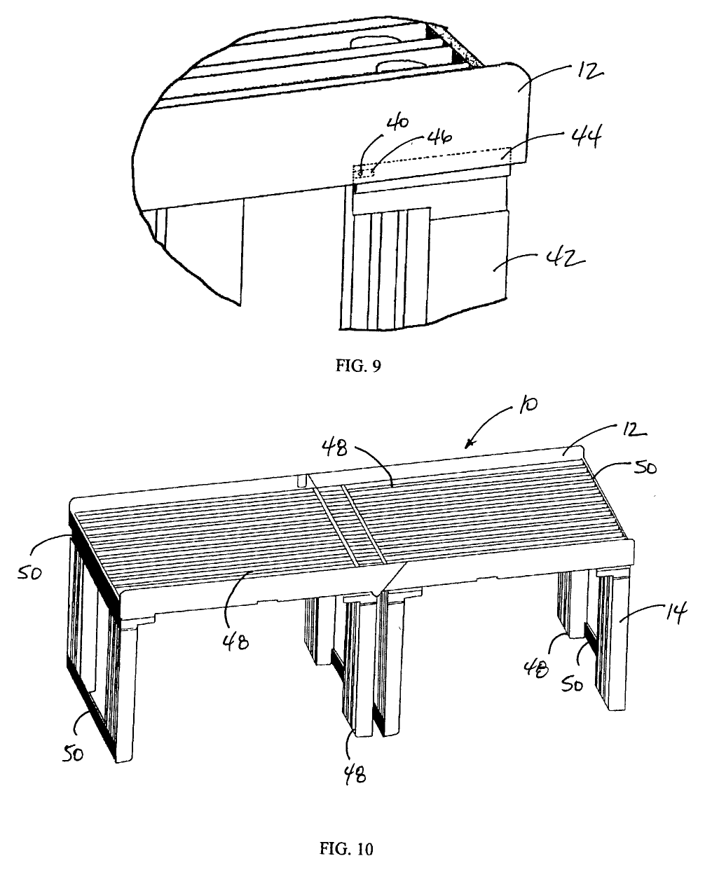

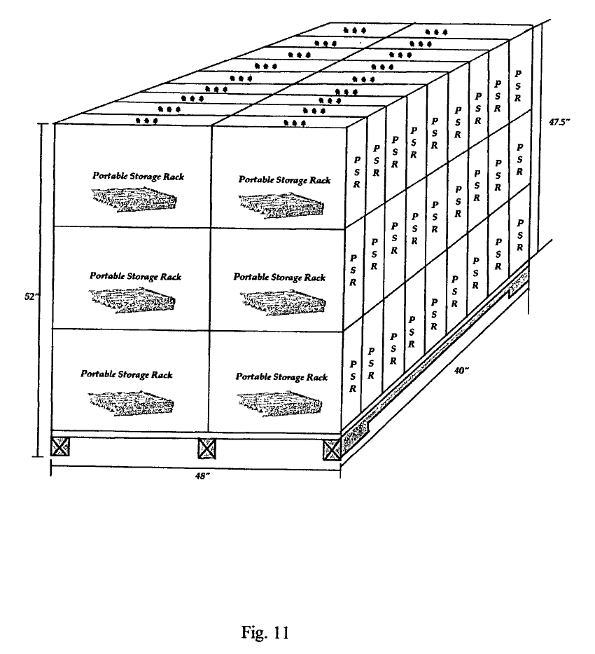

Referring to FIG. 10, an alternative embodiment of the portable storage rack of the present invention is illustrated. This embodiment is essentially identical to the embodiment described above, with the addition of a third leg 14 and a fourth leg 14 pivotally attached to the center end 16 of the first base panel 12 and the center end 16 of the second base panel 12, respectively. As with the legs that are attached to the leg ends of the base panels, the third and fourth legs 14 are pivotally attached to the center leg end of a base panel by any suitable means, such as the leg hinge 30 (FIG. 4). The third and fourth legs can be pivoted into upright positions as shown in FIG. 10, or collapsed and folded against the attached base panel. In this embodiment, as with the embodiment described above, after the first, second, third and fourth legs are collapsed, the base panels may be folded together to form the compact structure illustrated in FIG. 7.

The base panels 12, legs 14 and other features of the present invention are preferably formed from a lightweight yet structurally firm material, such as a high strength plastic. In particular, a 10% glass-filled polypropylene is preferably used to provide a portable storage rack that is strong, yet lightweight. The light weight of the preferred embodiment eases lifting and moving of the storage rack in and out of a cargo area or storing below a seat. The lightweight also decreases shipping costs associated with the sale of the present invention.

In the preferred embodiment, the base panels 12 and the legs 14 are formed from parallel slats 48, as illustrated in FIGS. 3, 4 and 10. The base panel slats and the leg slats are held in position by a brace 50 that extends perpendicularly to each slat at each end of the corresponding base panel or leg. The use of slats to form the base panels and the legs results in a lower weight storage rack. In alternative embodiments, the legs may include feet or claws at their lower ends, or hook and loop fasteners, such as Velcro®, to assist in maintaining the storage rack in a fixed location in the vehicle.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. For example, while the reference is made to “hinges” pivotally connecting the base panels and the legs, any suitable means may be used. Similarly, while the preferred embodiment incorporates slats to form the base panels and the legs, any suitable structure may be used to form the base panels and the legs without departing from the present invention. Thus, the breadth and scope of the present invention should not be limited by any of the above-described exemplary embodiments, but should be defined only in accordance with the following claims and their equivalents.

We claim:

1. A portable storage rack comprising:
a first base panel having a center end and a leg end;
a second base panel having a center end and a leg end;
the center end of the first base panel being pivotally attached to the center end of the second base panel;
a first leg pivotally attached to the leg end of the first base panel;
a second leg pivotally attached to the leg end of the second base panel;
the first and second base panels being foldable between a first base panel position wherein the base panels form a generally planar surface, and a second base panel position wherein the base panels are folded against each other; and
the first and second legs each being foldable between a first leg position wherein the leg is positioned generally perpendicular to the associated base panel, and a second leg position wherein the leg is folded against the associated base panel.

2. The portable storage rack of claim 1, wherein the base panels further comprise a positioning assembly to retain the base panels in the first position.

3. The portable storage rack of claim 2, wherein the positioning assembly comprises:
a vertical slot in the outside side wall of the first base panel adjacent to the center end of the first base panel, the slot having an open end at the upper surface of the first base panel, and a closed end; and
a vertical tab extending from the side wall of the second base panel adjacent to the center end such that the tab is received within the open end of the slot and rests against the closed end of the slot to lock the base panels in the first position.

4. The portable storage rack of claim 2, wherein the positioning assembly comprises:
a downwardly angled hook in the side wall of the first base panel adjacent to the center end of the first base panel; and
an upwardly angled hook extending from the center end of the second base panel such that the hook in the first base panel and the hook in the second base panel interconnect to lock the base panels in the first position.

5. The portable storage rack of claim 1, wherein:
the base panels include a peg extending inwardly from an inner side wall of the base panel; and
the legs include:
a support portion; and
an upper extended portion located adjacent to hinge on the leg and extending perpendicularly relative to the support portion, the upper extended portion including a slot; and
the peg being received within the leg slot when the leg is in the first leg position to lock the leg in the first leg position.

6. The portable storage rack of claim 1, wherein the base panels are formed from parallel slats, the base panel slats being held together by a brace at each end of the base panel.

7. The portable storage rack of claim 1, wherein the legs are formed from parallel slats, the leg slats being held together by a brace at each end of the leg.

8. The portable storage rack of claim 1, wherein:
the first base panel and the second base panel each have a lower surface;
when the legs are in the second leg position, the legs are each folded against the lower surface of the associated base panel; and
when the base panels are in the second base panel position, the lower surface of each base panel is folded against the lower surface of the other base panel.

9. The portable storage rack of claim 1 further comprising:
a third leg pivotally attached to the center end of the first base panel, the third leg each being foldable between a first leg position wherein the leg is positioned perpendicularly to the associated base panel, and a second leg position wherein the leg is folded against the associated base panel.
